(19) United States
(12) Patent Application Publication
(10) Pub. No.: US 2019/0163335 A1
(43) Pub. Date: May 30, 2019

(54) IMAGE INSPECTION DEVICE, IMAGE FORMING SYSTEM, AND PROGRAM

(71) Applicant: KONICA MINOLTA, INC., Tokyo (JP)

(72) Inventor: Syunji Kamei, Tokyo (JP)

(73) Assignee: KONICA MINOLTA, INC., Tokyo (JP)

(21) Appl. No.: 16/169,561

(22) Filed: Oct. 24, 2018

(30) Foreign Application Priority Data
Nov. 30, 2017 (JP) 2017-231228

(51) Int. Cl. G06F 3/0484; G06F 3/0482; G06T 7/00; G06T 1/20

(52) U.S. Cl. CPC G06F 3/0484; G06T 1/20; G06T 7/0006; G06F 3/0482

(57) ABSTRACT

An image inspection device for performing image determination by a plurality of inspection items includes: an image reader that obtains an image reading result obtained by reading an image on a transfer medium; an operator that receives an operation input of a user; a hardware processor that receives an input to select an inspection item by the operator from among inspection items which can be set, and performs image determination by decided inspection item on the image reading result read by the image reader; and a notifier that notifies whether the inspection item received by the hardware processor can be inspected within a time corresponding to predetermined productivity.

The entire disclosure of Japanese patent Application No. 2017-231228, filed on Nov. 30, 2017, is incorporated herein by reference in its entirety.

### BACKGROUND

### Technological Field

The present invention relates to an image inspection device, an image forming system, and a program capable of determining an image according to a reading result obtained by reading an image on a transfer medium.

### Description of the Related Art

In a field of an image forming device such as a copier, a printer, and a multifunction peripheral, a device has been known which determines a quality of an image and image quality adjustment by using the reading result obtained by reading the image on a paper sheet. For example, in a case where a read image is compared with image data for printing, and it is determined that the image has an abnormality in a case where the printed images do not coincide with each other. Furthermore, an image for adjustment is printed on one surface and a cutting margin of a paper sheet, an insert paper, and the like, and an image quality at the time of image formation is adjusted by reading the printed images. Furthermore, in a case where the image for adjustment is read, an abnormality of the image can be determined according to that the adjustment cannot be performed. In a case where it is determined that the image has an abnormality, the paper sheet is determined as a waste. Normally, processing of stopping output or of discharging the waste paper sheet to a discharge destination different from that in the normal case is performed.

In the image determination, a plurality of inspection items is used, and normally, determination on each item is performed.

However, in a case where the number of inspection items is large, time required for entire determination is increased, and there is a problem in that productivity (PPM) in image formation cannot be achieved.

However, in a case where the number of inspection items is large, time required for entire determination is increased, and there is a problem in that productivity (PPM) in image formation cannot be achieved.

In JP 2015-109653 A, it is determined whether print information can be verified as conveying a print medium, and the determination result is notified. When it is determined that the print information cannot be verified while conveying the print medium as following a discharge speed of the print medium, it is possible to issue a notification to lower the discharge speed of the print medium.

JP 2005-205693 A discloses that a specific inspection item of a plurality of inspection items is automatically set according to a priority.

However, the method in JP 2015-109653 A copes with a case where the print information cannot achieve the productivity by lowering the conveying speed of the paper sheet. There is a problem in that the productivity is deteriorated when using the coping method in JP 2015-109653 A.

Furthermore, according to JP 2005-205693 A, inspection items are uniformly set, and it is impossible to cope with a case where a situation changes. Alternatively, it is considered that all the set items are individually set by a user. However, there is a case where the productivity cannot be maintained.

### SUMMARY

The present invention has been made in view of above circumstances. An object of the present invention is to provide an image inspection device, an image forming system, and a program capable of appropriately and efficiently selecting an inspection item in image determination.

To achieve the abovementioned object, according to an aspect of the present invention, there is provided an image inspection device for performing image determination by a plurality of inspection items, and the image inspection device reflecting one aspect of the present invention comprises:

an image reader that obtains an image reading result obtained by reading an image on a transfer medium;

an operator that receives an operation input of a user;

a hardware processor that receives an input to select an inspection item by the operator from among inspection items which can be set, and performs image determination by decided inspection item on the image reading result read by the image reader; and

a notifier that notifies whether the inspection item received by the hardware processor can be inspected within a time corresponding to predetermined productivity.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram of a mechanical outline of an embodiment of the present invention;

FIG. 2 is a diagram of a control block of the same;

FIG. 3 is a flowchart of a procedure of determining an image by automatically setting inspection items based on priorities according to the same;

FIG. 4 is a diagram of an inspection item display screen according to the same;

FIG. 5 is a diagram of a warning screen for warning that productivity is not achieved according to the same;

FIG. 6 is a diagram of a reselected inspection item display screen according to the same;

FIG. 7 is a flowchart of a procedure of selecting an inspection item according to priority setting by a user according to the same;

FIG. 8 is a flowchart of a procedure of selecting an inspection item by priority setting which is fixed in a system according to the same;

FIG. 9 is a flowchart of a procedure of automatically setting an inspection item with a high priority according to the same;

FIG. 10 is a flowchart of a procedure of automatically setting an inspection item with high frequency according to the same;

FIG. 11 is a flowchart of a procedure of automatically setting an inspection item with high waste determination frequency according to the same;

FIG. 12 is a flowchart of a procedure of automatically setting an inspection item based on the inspection item with high waste determination frequency according to the same;

FIG. 13 is a diagram of an inspection item display screen according to another embodiment;

FIG. 14 is a flowchart of a procedure of determining an image in real time according to the same;

FIG. 15 is a flowchart of a procedure of determining an image regarding an inspection item which is excluded offline according to the same;

FIG. 16 is a flowchart of a procedure of adding an inspection item excluded in a machine of an image forming device and performing the inspection according to the same;

FIG. 17 is a flowchart of a procedure of determining an image while excluding the excluded inspection item according to the same; and

FIG. 18 is a flowchart of a procedure of determining an image as including the excluded inspection item and stopping conveyance of a paper sheet according to the same.

### DETAILED DESCRIPTION OF EMBODIMENTS

Hereinafter, one or more embodiments of the present invention will be described with reference to the drawings. However, the scope of the invention is not limited to the disclosed embodiments.

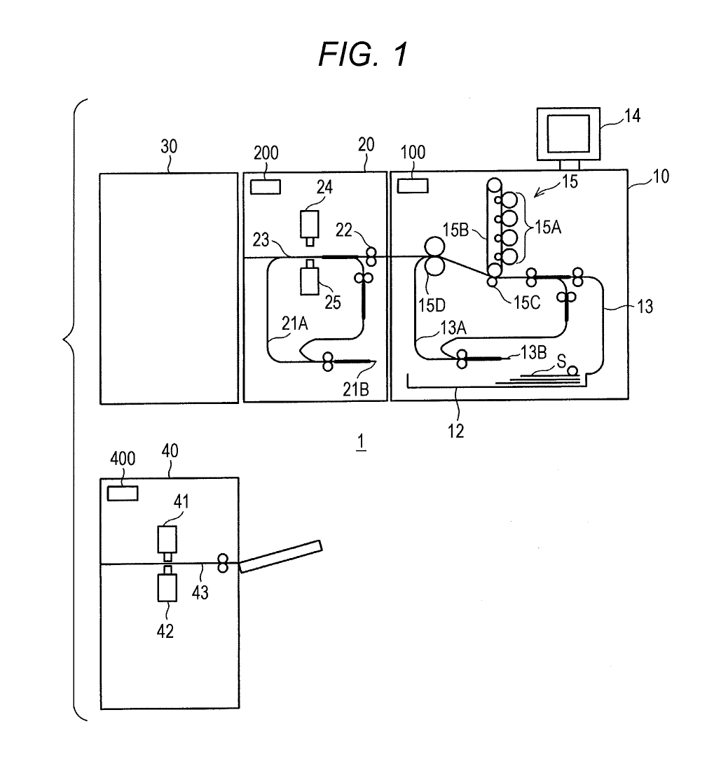

An image forming device 1 includes a device main body 10, an image reading device 20 connected to a post stage side of the device main body 10, and a post-processing device 30 connected to a post stage of the image reading device 20. In the present embodiment, description will be made as assuming that these devices are included in the image forming device. However, the image forming device may include the device main body 10, and an image forming system may include the image forming device and other devices. Furthermore, in the image forming system, the image reading device may be included in the image forming device, and the image reading device may be provided in the device main body 10. In FIG. 1, a reference numeral 40 indicates an offline image reading device which is not used in the present embodiment.

In the device main body 10, a main body sheet feeder 12 having a plurality of paper sheet feeding stages is arranged on a lower side of a housing, and paper sheets are stored in the main body sheet feeder 12. The paper sheet corresponds to a transfer medium of the present invention. The transfer medium is not limited to paper and may be cloth, plastic, and the like.

A conveyance path 13 is provided in the device main body 10, and the paper sheet fed from the main body sheet feeder 12 is conveyed to a downstream side through the conveyance path 13.

An image former 15 is provided near the middle of the conveyance path 13. The image former 15 includes photoreceptors 15A for respective colors (cyan (C), magenta (M), yellow (Y), and black (K)) and includes a charger, a LD, and a developer, which are not illustrated, around each photoreceptor 15A. In addition, the image former 15 includes an intermediate transfer belt 15B, a secondary transfer unit 15C, and a fixer 15D. An image on each photoreceptor 15A is transferred on the intermediate transfer belt 15B, and the secondary transfer unit 15C transfers the image on the intermediate transfer belt 15B on a paper sheet which is conveyed through the conveyance path 13. The fixer 15D is arranged in the conveyance path 13 on the downstream side of the secondary transfer unit 15C, and fixes the image on the paper sheet on the paper sheet on which the image is formed and which is conveyed through the conveyance path 13 by applying heat and pressure.

The image former 15 includes the photoreceptors 15A, the charger, the LD, and the developer which are not illustrated, the intermediate transfer belt 15B, the secondary transfer unit 15C, the fixer 15D, and the like. In the present embodiment, it is assumed that a color printer be used. However, the present invention is not limited to this, and may be an image forming device which can print with only a single color such as monochrome.

The conveyance path 13 is branched into a reverse conveyance path 13A on the downstream side of the fixer 15D, and a downstream side of the reverse conveyance path 13A joins the conveyance path 13 on the upstream side of the image former 15. At the middle of the reverse conveyance path 13A, the reverse conveyance path 13A is branched into an evacuation conveyance path 13B, and the paper sheet can be introduced into the evacuation conveyance path 13B and can be conveyed to the downstream side of the reverse conveyance path 13A by switching the front and back of the paper sheet.

In a case where an image is formed on a rear surface of the paper sheet, after the paper sheet has been temporarily fed from the reverse conveyance path 13A to the evacuation conveyance path 13B, the paper sheet is fed from the evacuation conveyance path 13B to the reverse conveyance path 13A on the downstream side as switching the front and back of the paper sheet and is circulated to the conveyance path 13. The paper sheet of which the front and rear surfaces of the paper sheet are reversed is fed through the conveyance path 13, and the image former 15 can form an image on the rear surface of the paper sheet. The downstream side of the conveyance path 13 is connected to a conveyance path 23 of the image reading device 20.

In addition, an operator 14 is provided on an upper side of the housing of the device main body 10. The operator 14 can be configured of a touch-panel-type LCD, and can be operated by an operator and can display information. The LCD serves as the operator and a display and functions as an operation display. Note that it is possible that the operator includes a mouse, a tablet, and the like and is formed separately from the display. Furthermore, the LCD may be movable.

The device main body 10 includes an image controller 100 which controls the entire image forming device. The image controller 100 can include a CPU, a program executed by the CPU, a storage for storing a parameter and a working region, and the like. The image controller 100 can receive an image reading result by the image reading device 20. Therefore, the image controller 100 corresponds to a controller of the present invention.

The image controller 100 can determine whether the image is good or bad and whether the image satisfies a print quality based on the reading result. In a case where the quality of the image is determined, the paper sheet can be assumed as a waste sheet by the determination indicating that the image is a defective image. Furthermore, in a case where it is determined whether the image satisfies the print quality, for example, an image density, an image position, and a color shift are determined, a correction amount is calculated as necessary, and feedback can be applied to the following paper sheets.

The determination is made based on predetermined inspection items. The inspection items include a kind of determination, a determination object (size and image), determination accuracy, and the like. Although the number of inspection items can be plural, determination may be made on a single inspection item. The determination of the image is performed so as to achieve productivity (PPM). That is, the determination is performed within a paper sheet conveyance interval.

In processing after the determination, as described above, in a case where the paper sheet is determined as a waste due to an abnormality in an image, it is possible to stop printing and discharge the paper sheet in the image forming device. Furthermore, regarding the adjustment of the image, the image is adjusted at the time of subsequent image formation. However, processing according to the image determination result in the present invention is not limited to specific processing, and appropriate processing can be performed depending on the purpose of the image determination.

The image reading device 20 includes the conveyance path 23 connected to the conveyance path 13 of the device main body 10 and conveys the paper sheet conveyed from the device main body 10 to the downstream side through the conveyance path 23 by a conveying roller 22 and the like.

In the middle of the conveyance path 23, an image reading sensor 24 which reads an image on an upper surface of the paper sheet and an image reading sensor 25 which reads an image on a lower surface of the paper sheet are provided. The reading results of the image reading sensors 24 and 25 are transmitted to the image controller 100. The image reading sensors 24 and 25 may be line sensors including a CMOS sensor and a CCD sensor or may be a colorimeter which reads an image at points. The image reading sensors 24 and 25 form a part of an image reader of the present invention.

The conveyance path 23 is branched into a reverse conveyance path 23 A on the downstream side of the image reading sensors 24 and 25, and the downstream side of the reverse conveyance path 23A joins the conveyance path 23 on the upstream side of the image reading sensors 24 and 25. At the middle of the reverse conveyance path 23A, an evacuation conveyance path 23B is branched, and the paper sheet, to be introduced to the evacuation conveyance path 23B, of which the front and back of the paper sheet are reversed is conveyed to the downstream side of the reverse conveyance path 23A.

In the present embodiment, a configuration having two image reading sensors has been described. However, the number of the image reading sensors in the present invention is not limited and may be one or equal to or more than three. Types of multiple image reading sensors may be different from each other.

The image reading device 20 includes a reading controller 200 and can control the image reading sensors 24 and 25, temporarily store the reading results of the image reading sensors 24 and 25 in an image memory in the image reading device 20, and transmit the reading results to the image controller 100.

Note that, in the present embodiment, description has been made as assuming that the image controller 100 determines the image. However, the image reading device 20 may perform image determination. In this case, the reading controller 200 can obtain the images read by the image reading sensors 24 and 25 and can determine the image.

In a case where the image controller 100 determines the image, the device main body 10 corresponds to an image inspection device of the present invention, and the image inspection device may further include the image reading device 20. In a case where the reading controller 200 determines the image, the image reading device 20 corresponds to the image inspection device of the present invention, and the image inspection device may include the device main body 10. In the latter case, the reading controller functions as the controller of the present invention.

As described above, it is possible that the image inspection device of the present invention includes or does not include the image reader, and in addition, it is possible that the image inspection device includes or does not include the image former. Furthermore, the image inspection device and the image forming device may form the image forming system. The controller may be included in either one of an image forming device main body or an image forming device main body.

Furthermore, in addition to the device main body and the image reading device, the controller of the present invention may be a controller which is provided outside the device main body and the image reading device, is connected to the device main body and the image reading device via a network, a cable, and the like, and determines the image by obtaining the image reading result. The controller can be included in an external device, a management device which manages the image forming device, and the like. In this case, the external device and the management device correspond to the image inspection device of the present invention.

The image controller 100 and the reading controller 200 can determine the quality of the image and a color shift in the image by comparing reference data with image data read by the image reader. For example, if both of the reference data and the image data match, it is determined that the image is normal. If the reference data does not match the image data, determination indicating that an abnormality occurs in the image and determination indicating that it is necessary to adjust the image can be made. Criteria of the image determination can be appropriately set.

The post-processing device 30 performs predetermined processing such as stapling, punching, saddle stitching, and the like and may perform a plurality of kinds of post-processing. The post-processing device 30 includes a plurality of paper sheet discharge destinations and can discharge paper sheets which have been determined as waste sheets as separating the waste sheets from normal output paper sheets.

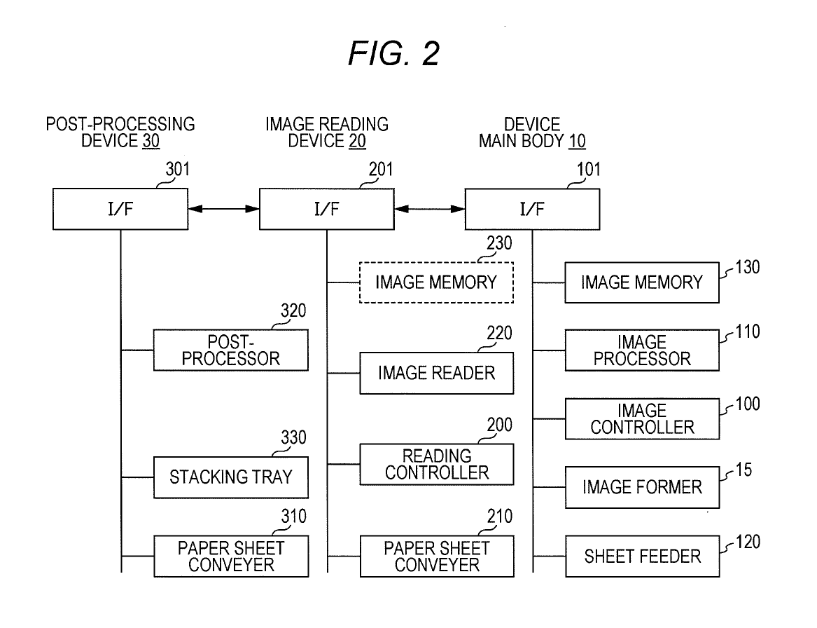

Next, a control block of the image forming device 1 will be described with reference to FIG. 2.

The device main body 10 includes an interface 101 which communicates with connected devices, and the device main body 10 is connected to an interface 201 of the image reading device 20.

The device main body 10 includes the image controller 100 which controls the entire image forming device 1, and the image controller 100 is connected to an image processor 110. The image processor 110 performs image processing including reading image data and writing an image.

The image former 15 is controllably connected to the image controller 100, and an image can be formed on a paper sheet based on the read image data and RIP data.

The image data can be temporarily stored in an image memory 130 and can be used to form an image.

A main body sheet feeder 120 feeds paper sheets to the image former 15 and includes the main body sheet feeder 12.

The image reading device 20 includes the interface 201 which communicates with the interface 101 of the device main body 10 and further communicates with an interface of the post-processing device 30 at the post stage.

The image reading device 20 includes the reading controller 200 which controls the image reading device 20 and can control an operation of the image reading device 20 according to a control command from the image controller 100. The reading controller 200 includes a CPU, a program operated on the CPU, a storage, and the like.

Furthermore, in a case where the image read by the image reading device 20 is determined, the reading controller 200 can make determination.

A paper sheet conveyer 210 is controllably connected to the reading controller 200, and the paper sheet fed from the device main body 10 is conveyed through the conveyance path 23 in a state where the image can be read, and further conveyed to the post stage.

An image reader 220 is controllably connected to the reading controller 200. The image reader 220 includes the image reading sensors 24 and 25. The reading result read by the image reader 220 is temporarily transmitted to the reading controller 200 and determined or transmitted to the image controller 100 so as to be determined by the image controller 100.

In addition, an image memory 230 is controllably connected to the reading controller 200. The reading result read by the image reader 220 is stored in the image memory 230. Note that it is possible to store the reading result in an image memory provided in the device main body 10 without providing the image memory 230 in the image reading device 20.

The post-processing device 30 includes an interface 301 which communicates with the interface 201 of the image reading device 20.

A paper sheet conveyer 310 is provided in the post-processing device 30, and the paper sheet conveyer 310 conveys a paper sheet fed from the image reading device 20, performs post-processing on the paper sheet, and discharges the paper sheet. Furthermore, according to post-processing setting, the paper sheet conveyer 310 may discharge the paper sheet without performing the post-processing.

A post-processor 320 is provided in the post-processing device 30. The post-processor 320 performs desired post-processing. The number of types of post-processing may be one or equal to or more than two. The paper sheet is discharged to a stacking tray 330 or a discharge tray which is not illustrated.

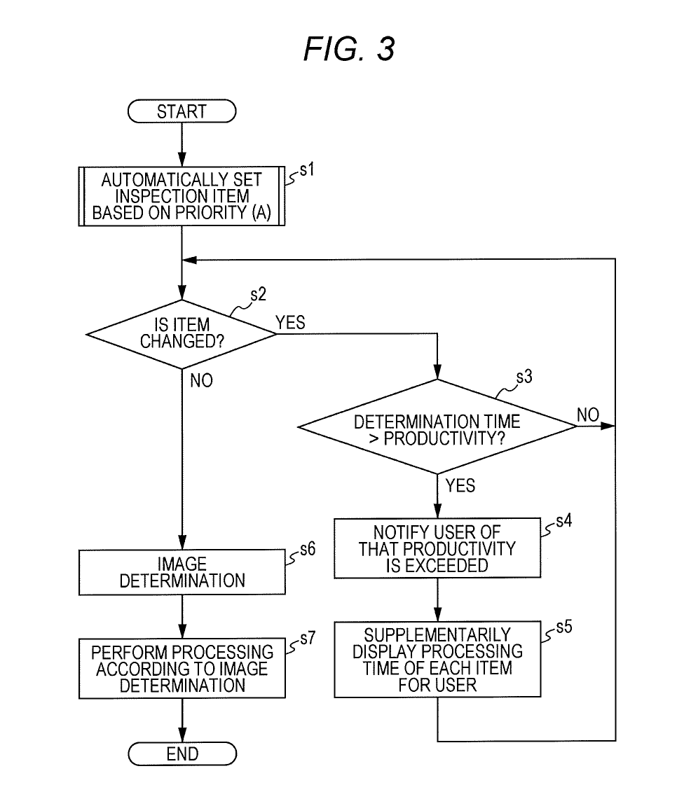

In the present embodiment, in a case where the image formed by the image former is determined, a priority is set for the inspection items, and the determination is made for each page so as to achieve the productivity. The determination may be made for each job so as to achieve the productivity. This will be described below with reference to the flowchart in FIG. 3. The following procedure is performed under control by the controller.

First, an inspection item is automatically set based on priority setting (step s1, process A). After that, it is determined whether the inspection item is changed (step s2). The present invention does not necessarily include the priority setting. The priority setting can be realized by a part of a function of a program executed by the controller. The part of the function corresponds to a priority setter of the present invention.

In a case where the inspection item is change (step s2, Y), a determination time and productivity are compared with each other after the changed, and it is determined whether the determination time exceeds the productivity (step s3). In a case where the determination time exceeds the productivity (step s3, Y), since the productivity cannot be achieved, a user is notified that the productivity cannot be achieved (step s4). Predetermined productivity can be appropriately set according to ppm (the number of printed paper sheets per minute) and the like. The notification may be displayed on the operator, notified by voice, and transmitted to the other device via a network and the like.

In a case where the inspection item is changed, the determination time and the productivity are compared with each other again after the change, and it is determined whether the determination time exceeds the productivity. The determination can be realized by executing the program by the controller, and in a case where the determination time exceeds the productivity, the notification is issued. The notification may be issued by being displayed on the operator or by a device outside the image forming device. The notification can be issued by display, voice, and the like, and a notification method is not particularly limited. Therefore, a notifier of the present invention includes a part of the function of the program of the controller, the operator, and the like.

The inspection item can be manually changed by a user's operation input to the operator. The operation input is sent to the controller, and input result is received by executing the program by the controller. Therefore, a receiver of the present invention includes a part of the function of the program executed by the controller.

Next, a processing time is supplementarily displayed for easy understanding of inspection items to be excluded in order to make determination so as to achieve the productivity (step s5), it is determined again in step s3 whether the item is changed.

In a case where the inspection item is not changed (step s2, N), the inspection item is decided, and the image determination is performed (step s6). Then, processing according to the image determination is performed (step s7), and the processing is terminated. As the processing according to the image determination, for example, in a case where the image is defective as described above, processing for stopping discharge of waste paper sheets and stopping a device is performed, and image quality correction processing is performed in the determination of the print quality as necessary. The image determination can be realized by a part of the function of the program executed by the controller, and the part of the function forms an inspection executor of the present invention.

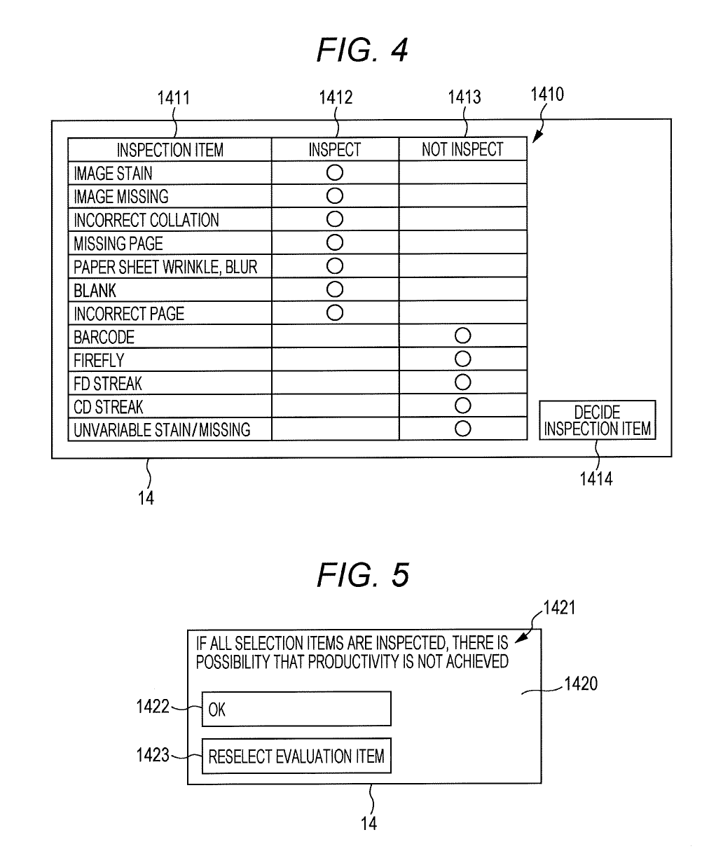

FIG. 4 illustrates an inspection item display screen 1410 in which the inspection items are displayed on a screen such as the operator 14. Note that the display screen may be displayed outside the image forming device.

In the inspection item display screen 1410, inspection items to be inspected and inspection items which are not inspected are automatically selected. The display on the screen is performed under the control by the controller.

In the inspection item display screen 1410, an a list of inspection items which can be inspected 1411 is displayed. Regarding each inspection item, a circle is displayed in an inspection execution item field 1412 in a case where the inspection is executed and a circle is displayed in an inspection item inexecution field 1413 in a case where the inspection is not executed. In the inspection item list 1411, a priority of an item described on an upper side of FIG. 4 is set to be higher. The inspection item and the priority of the inspection item can be stored in the storage be called by the controller as necessary.

The priority may be fixedly set relative to the inspection item in advance by machine setting and may be set by a user via the operator 14. Furthermore, setting may be used in which the priority is changed according to the execution of the inspection. For example, the priority of the inspection item with high inspection frequency may be set to be relatively high, and the priority of the inspection item which is determined as defective at high frequency in the image determination may be set to be relatively high. Furthermore, the inspection item and a job are stored in association with each other, and a correlation between the job and the inspection item is calculated. Then, the priority of the inspection item having a high correlation may be automatically set at the time of printing of other job.

When the inspection item is automatically set, as illustrated in the flowchart in FIG. 3, two parameters including an evaluation time (total time of inspection processing time of image determination) and the productivity are required.

Actual data in the past can be used with respect to the evaluation time, and in addition, the evaluation time can be calculated by inspecting all the items in advance at the time of performing a proof job. When all the items are inspected, a long processing time is taken, and the productivity is largely delayed. In these circumstances, a processing time table which has been previously prepared can be referred. Regarding the productivity (page per minutes: PPM), a paper sheet passing time for each job can be calculated as the productivity as focusing on the feature that the paper sheet passing time is changed according to the job. The productivity can be indicated by a paper sheet conveyance interval time.

When a screen for selecting the inspection item is displayed, the inspection item is automatically selected by using a sequence in FIG. 3. At that time, it is preferable that selection items and items which are not selected are displayed in an easy-to-understand manner as illustrated in FIG. 4. When a user changes the inspection item from automatic setting items, processing time is calculated again whether the time is within the productivity. The calculation may be made at a timing when an “inspection item decided” button illustrated in FIG. 4 is pressed, and the calculation may be made at the time of selecting whether each inspection item is inspected.

In a case where the inspection item selection is automatically set, a user may further change the item via the operator 14. A change method is not particularly limited. For example, by pressing the inspection execution item field 1412, the inspection item can be changed to an inspection item to be inspected, and by pressing the inspection item inexecution field 1413, unnecessary inspection item is changed to an item which is not inspected. In a case where the displayed inspection items may be used or in a case where the inspection item is changed, the inspection items are decided by pressing an inspection item deciding button 1414.

However, when the inspection item is selected as described above, it is necessary to perform determination processing so as to achieve the productivity. In the automatic selection, the inspection item can be selected from this point of view. If a user manually changes the inspection item, there is a possibility that a condition such that the productivity can be achieved cannot be satisfied.

FIG. 5 illustrates a warning screen for warning that the productivity is not achieved 1420 displayed on the operator 14 when it is determined that the productivity cannot be achieved due to a change in the inspection items. This screen is displayed under the control by the controller. In this screen, a warning display 1421 indicating a possibility that the productivity is not achieved if all the selected inspection items are inspected is displayed. An OK button 1422 and a “reselect evaluation item” button 1423 are displayed in the screen. When the OK button is pressed, image determination is made with the selected inspection items. When the “reselect evaluation item” button 1423 is pressed, a screen for reselecting the inspection items is displayed, and the inspection item can be changed.

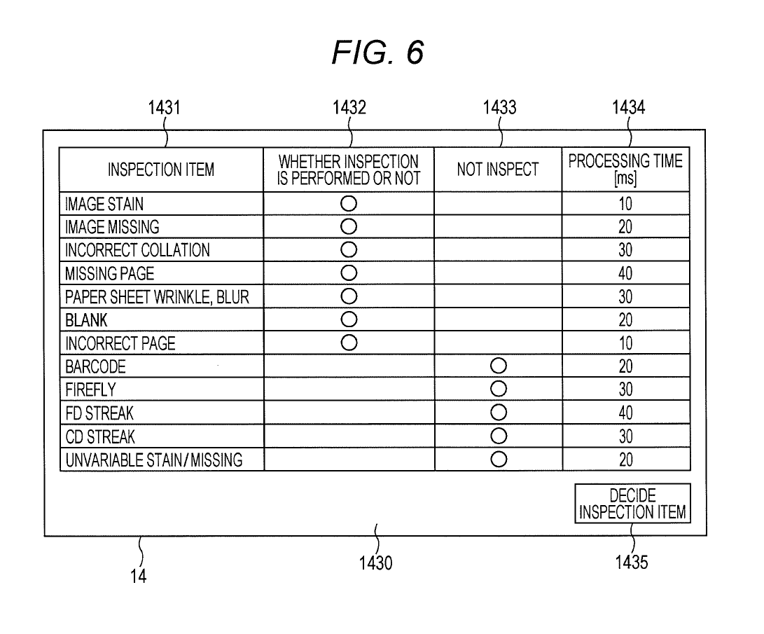

FIG. 6 illustrates a reselected inspection item display screen 1430 which is displayed on the operator 14 and facilitates reselection. The reselected inspection item display screen 1430 is not necessarily used for reselection and may be displayed from the beginning as a screen for displaying the inspection items, and may be displayed only in a case where the reselection is made. The display on the screen is performed under the control by the controller.

Similarly to the inspection item display screen 1410, in the reselected inspection item display screen 1430, a list of inspection items which can be inspected 1431, an inspection execution item field 1432, and an inspection item inexecution field 1433 are displayed, and in each item field, circles indicating execution of inspection and inexecution of inspection are displayed.

Furthermore, in the reselected inspection item display screen 1430, an assumed processing time for each inspection item is displayed in a processing time field 1434, in addition to the above fields. Each processing time is obtained based on actual data and data obtained by proof output. Furthermore, the processing time may be obtained by calculation, and an obtaining method is not particularly limited.

When the inspection item is selected, it is possible to select and exclude the inspection item while confirming the processing time of the inspection item. At this time, a total value of the selected inspection times may be displayed. In a case where the determination time cannot achieve the productivity, the inspection item can be selected so as to shorten the processing time. At that time, a time that exceeds the productivity may be displayed on the screen.

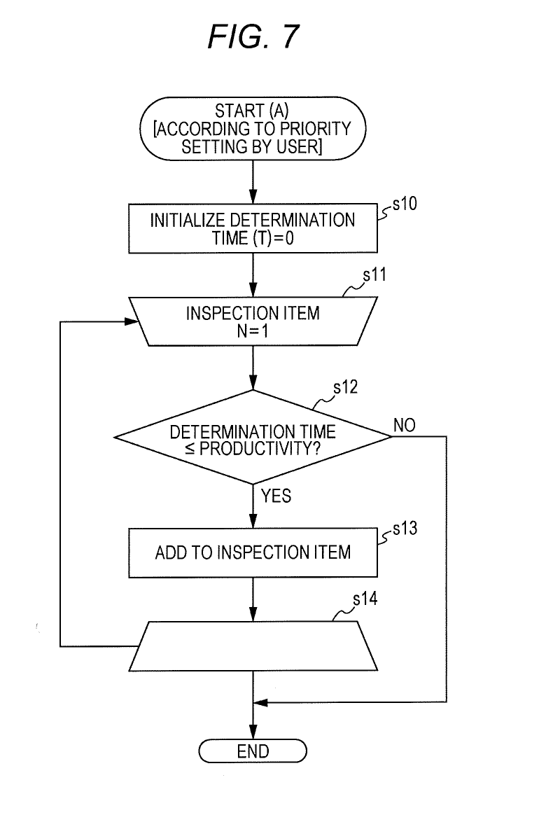

A procedure of selecting the inspection item according to the user's priority setting will be described with reference to the flowchart in FIG. 7. The following procedure is performed under control by the controller. In the inspection item setting according to the priority setting, all the inspection items can be manually set.

First, a determination time T in the determination is initialized to zero (step s10). Next, an inspection item order N is set to one which is an initial value (step s11), and processing of repeating setting until the number reaches a value at which the inspection can be performed (step s14). In the repeated processing, it is determined whether the determination time is equal to or less than the productivity (step s12). The determination time is calculated as a sum of the processing times of the inspections. In a case where the determination time is not equal to or less than the productivity (step s12, N), the processing is terminated. By excluding the number N from the number of inspection items, and the number of inspection items at this time is N−1. In a case where the determination time is equal to or less than the productivity (step s12, Y), a Nth inspection item is added to the inspection execution items, the processing time of the inspection item is added to the determination time (step s13), one is added to N, and the procedure returns to step s11. By repeating this processing, the inspection items can be added until the productivity can be achieved. The addition of the inspection item is realized by a part of the function of the program executed by the controller, and the part of the function corresponds to an additional setter of the present invention.

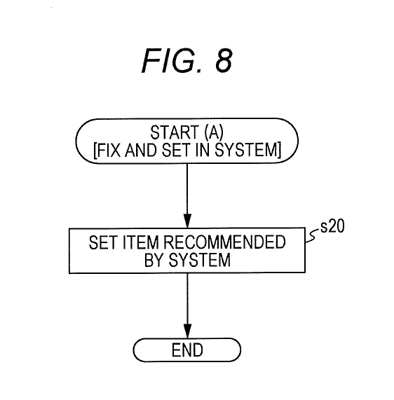

A procedure in a case where the inspection items are fixed will be described with reference to the flowchart in FIG. 8. The following procedure is performed under control by the controller.

In this case, items recommended by the system are set (step s20), and the procedure is terminated.

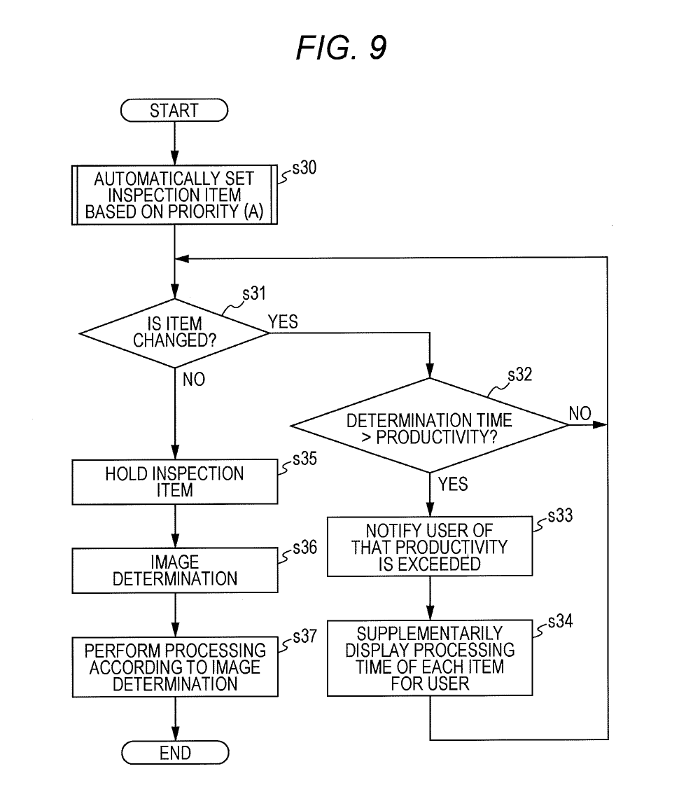

Next, a procedure of automatically setting an inspection item with a high priority will be described with reference to the flowchart in FIG. 9. The following procedure is performed under control by the controller.

In this procedure, the inspection item is held in the storage for each job execution. At the time of executing next job, inspection items are automatically set from an inspection item with high inspection frequency based on stored inspection item frequency information.

First, the inspection item is automatically set based on the priority (step s30).

Next, it is determined whether the inspection item is changed (step s31). In a case where the inspection item is changed, it is determined whether the determination time exceeds the productivity (step s32). In a case where the determination time does not exceed the productivity (step s32, N), in addition, it is determined whether the item is changed (step s31). In a case where the determination time exceeds the productivity (step s32, Y), a user is notified that the determination time exceeds the productivity. The notification can be displayed on the operator, notified by voice, and transmitted to the other device via a network and the like. Subsequently, a processing time for each item is supplementarily displayed to a user (step s34), and in addition, it is determined whether the item is changed (step s31).

In a case where the item is not changed (step s31, N), the inspection item is held (step s35), and the image determination is made (step s36). Subsequently, processing according to the image determination is performed (step s37), and then, the procedure is terminated.

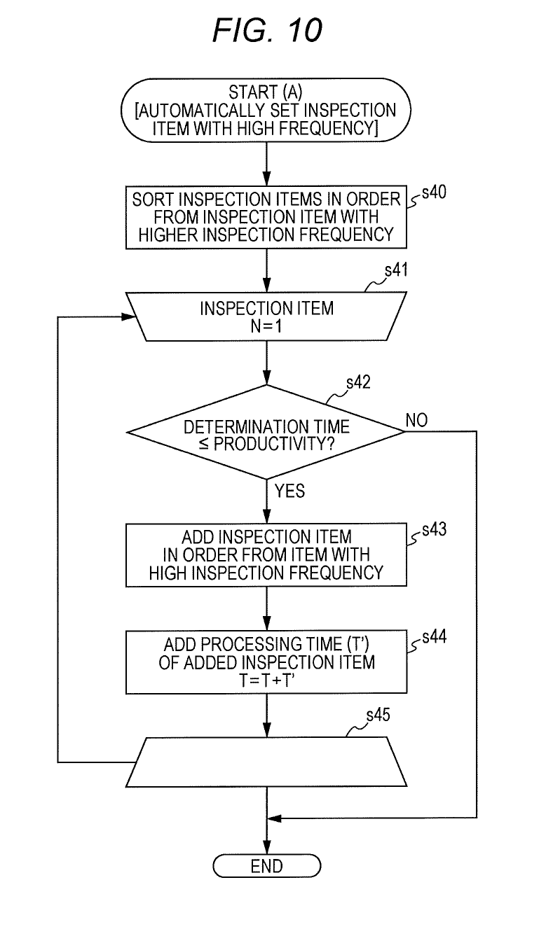

Next, a procedure of automatically setting the inspection item with high frequency described in the flowchart in FIG. 9 will be described with reference to the flowchart in FIG. 10. The following procedure is performed under control by the controller.

As the procedure starts, the inspection items with high inspection frequency are sorted (step s40). Next, the number of inspection items N is initialized to be one (step s41), and processing is repeated until the number reaches the selectable number of inspection items (step s45). In the repeated processing, it is determined whether the determination time is equal to or less than the productivity (step s42). In a case where the determination time exceeds the productivity (step s42, N), a Nth inspection item is not added to the determination inspection items, and the procedure is terminated.

In a case where the determination time is equal to or less than the productivity (step s42, Y), the inspection items are added in order from the inspection item with high inspection frequency (step s43), and processing times of the added inspection items (T′) are added to a total time T. The total time is the determination time. Next, one is added to N, the procedure returns to step s41, and the processing is repeatedly performed.

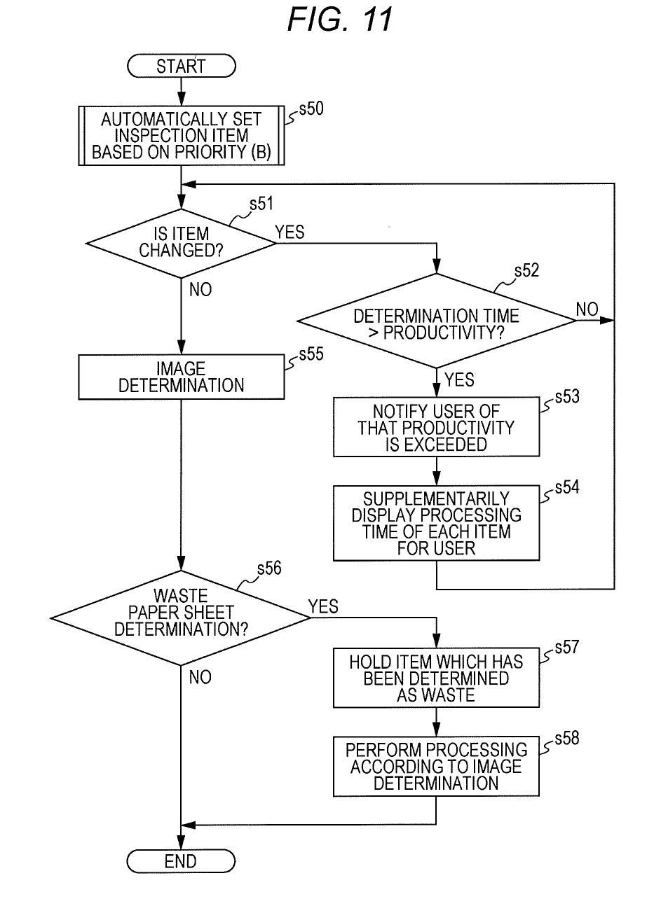

Next, a procedure of automatically setting an inspection item with which a paper sheet is determined as waste at high frequency will be described with reference to the flowchart in FIG. 11. The following procedure is performed under control by the controller.

First, the inspection item is automatically set based on the priority (processing B, step s50). Next, it is determined whether the inspection item is changed (step s51). In a case where the inspection item is changed, it is determined whether the determination time exceeds the productivity (step s52). In a case where the determination time does not exceed the productivity (step s52, N), in addition, it is determined whether the item is changed (step s51). In a case where the determination time exceeds the productivity (step s52, Y), a user is notified that the determination time exceeds the productivity. The notification can be displayed on the operator, notified by voice, and transmitted to the other device via a network and the like. Subsequently, a processing time for each item is supplementarily displayed to a user (step s54), and in addition, it is determined whether the item is changed (step s31).

In a case where the item is not changed (step s51, N), the image determination is made (step s55), and it is determined whether the paper sheet is determined as the waste paper sheet (step s56). In a case where it is not determined that the paper sheet is a waste paper sheet (step s56, N), the procedure is terminated. In a case where it is determined that the paper sheet is a waste paper sheet (step s56, Y), the item which is determined as waste is held (step s57), and processing according to the image determination is performed (step s58). After that, the procedure is terminated. By holding the item which is determined as the waste in step s57, it is possible to update waste determination frequency. In this procedure, the inspection item is automatically set according to the waste determination frequency. However, the inspection item may be automatically set according to frequency of a defect in the print quality of the image.

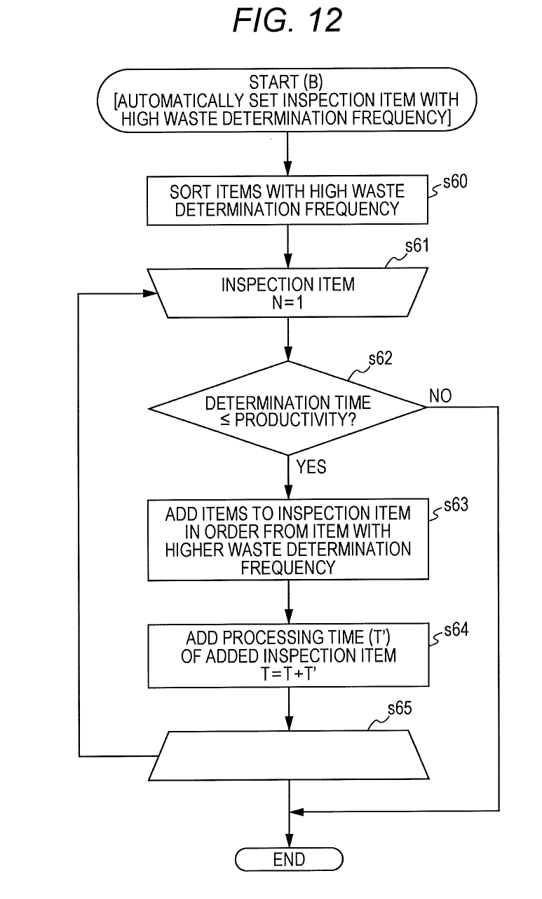

Next, a procedure B of automatically setting an inspection item according to the inspection item with high waste determination frequency will be described with reference to the flowchart in FIG. 12. The following procedure is performed under control by the controller.

First, the inspection items with high waste determination frequency are sorted (step s60). The number of inspection items N is set to one as an initial value (step s61), and processing is repeated until the number reaches the selectable number of inspection items (step s65).

In the repeated processing, it is determined whether the determination time is equal to or less than the productivity (step s62). In a case where the determination time is not equal to or less than the productivity (step s62, N), the procedure is terminated. In a case where the determination time is equal to or less than the productivity (step s62, Y), the inspection items are added in order from the inspection item with high waste determination frequency (step s63), and a processing time T′ of the added inspection item is added to the total time T of the inspection items (step s64). The total time T is the determination time. Next, one is added to N, the procedure returns to step s61, and the processing is repeatedly performed.

In the above embodiment, the inspection item is selected so that the determination time is equal to or less than the productivity from viewpoint of the productivity, and determination is not made regarding other inspection items. Regarding the inspection item which is not inspected can be inspected by other method.

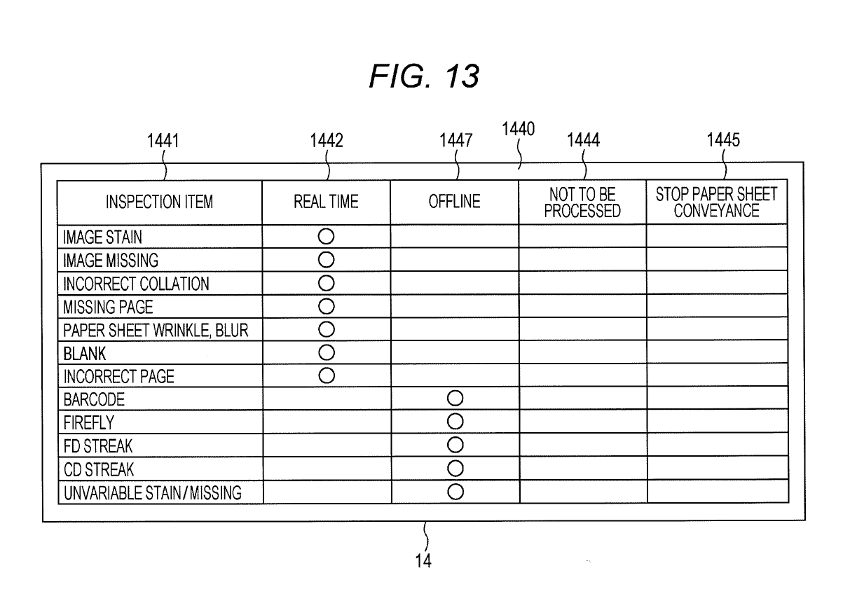

FIG. 13 illustrates an inspection item display screen 1440 displayed on the operator 14. Similarly to the inspection item display screen 1410, a list of inspection items which can be inspected 1441 is displayed. The inspection execution item is indicated by a circle displayed in a real time field 1442. Other items are not inspected in real time. However, as items to be inspected, an offline field 1447, a unprocessed field 1444, and a paper sheet conveyance stop field 1445 are displayed. In this example, the inspection items other than the inspection item which is inspected in real time are set to be inspected offline.

The offline image reading device 40 illustrated in FIG. 1 can perform offline search. The image reading device 40 includes a conveyance path 43 and image reading sensors 41 and 42 along the conveyance path 43. The image reading sensor 41 reads an image on an upper surface of a paper sheet conveyed through the conveyance path 43, and the image reading sensor 42 reads an image on a lower surface of the paper sheet conveyed through the conveyance path 43.

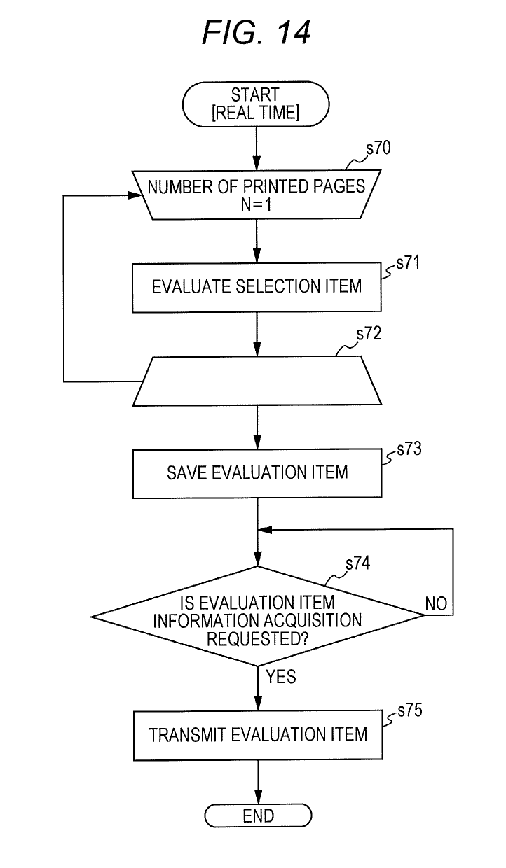

First, a procedure of determining an image in real time will be described with reference to the flowchart in FIG. 14.

First, one is initially set to the number of printed pages N (step s70), and processing is repeatedly performed to the final page (step s72). In the repeated processing, the selected inspection item is evaluated (step s71). The processing is sequentially repeated as adding one to N.

When the repeated processing is completed, an evaluation item is saved (step s73), and it is determined whether an evaluation item information acquisition is requested (step s74). If there is no request (step s74, N), the request is waited.

When the acquisition is requested (step s74, Y), processing of transmitting evaluation items is performed (step s75), and after that, the processing is terminated. In this example, for example, the image forming device is electrically connected to the offline image reading device via a network and the like, and the evaluation item can be transmitted in response to the request from the offline side. Furthermore, in a case where the devices are not electrically connected to each other, it is possible to store the evaluation item in a movable storage medium and obtain the content of the evaluation item by the offline side.

After the determination has been made, the discharged paper sheet is arranged in the offline image reading device, that is, the image inspection device, and determination on remaining evaluation items is performed. When the remaining items are determined by the offline image inspection device, first, the offline inspection device is inquired about inspected items, and determination on only the uninspected item is performed.

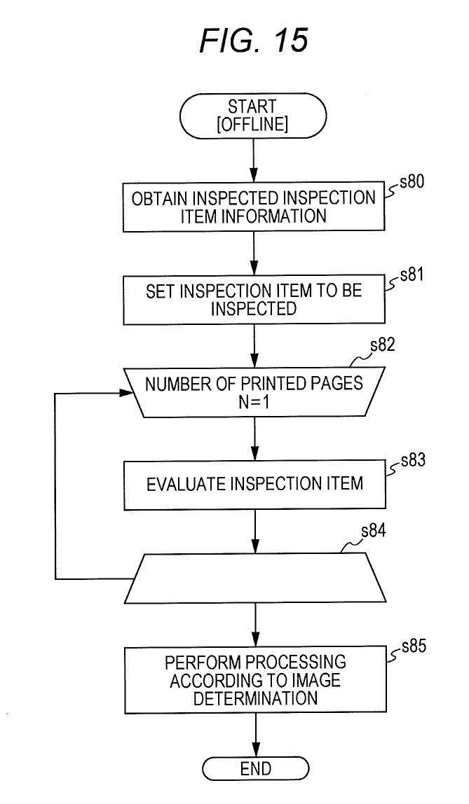

Next, a determination procedure by the offline side will be described with reference to the flowchart in FIG. 15.

The procedure by the offline side can be, for example, by control of a reading controller 400 included in the image reading device 40. Furthermore, in a case where the image reading device 40 is electrically connected to the image forming device, the control may be performed by a controller of the image forming device.

First, information on inspected inspection item is obtained (step s80). As described above, the information can be obtained via the electrical connection, a movable storage, and the like.

The inspection item to be inspected is set by the offline side based on the information (step s81). Next, one is set as an initial value of the number of printed pages N (step s82), and processing is repeatedly performed to the final page (step s84). During the repeated processing, the inspection item is evaluated (step s83), one is added to N, and the processing is repeatedly performed. After the repeated processing, processing according to the image determination is performed, and the procedure is terminated. As described above, in the present embodiment, regarding the item which is not inspected in real time, the image determination can be performed by using the offline device.

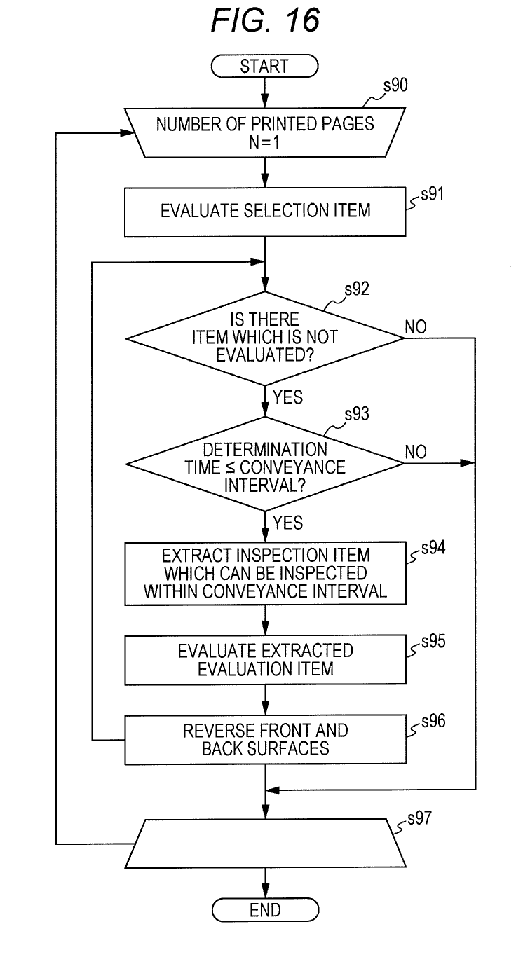

Next, a procedure of selecting an inspection item in a machine of the image forming device will be described with reference to the flowchart in FIG. 16.

One is set as an initial value of the number of printed pages N (step s90), and processing can be repeatedly performed to the final page (step s97).

In the repeated processing, first, a selection item is evaluated (step s91), and it is determined whether there is an item which is not evaluated (step s92). If there is no item which is not evaluated (step s92, N), one is added to N, and the procedure proceeds to step s90, and the processing is repeatedly performed.

In a case where there is an item which is not evaluated (step s92, Y), it is determined whether the determination time is equal to or shorter than a conveyance interval. In a case where the determination time is not equal to or shorter than the conveyance interval (step s92, N), one is added to N, and the procedure proceeds to step s90, and the processing is repeatedly performed.

In a case where the determination time is equal to or shorter than the conveyance interval (step s93, Y), the inspection item which can be evaluated within the conveyance interval is extracted (step s94), and the extracted evaluation item is evaluated (step s95). Next, the front and the back surfaces are reversed (step s96), the procedure proceeds to step s92, and it is determined whether there is an item which is not evaluated.

Note that, in this example, the paper sheet is held by using a paper sheet inverting mechanism and the like, and the remaining evaluation items are evaluated when the paper sheet is held, and the paper sheet is discharged. However, the control may be performed with a structure in which the paper sheet is held by a stacker and the like in the post stage without using the inverting mechanism.

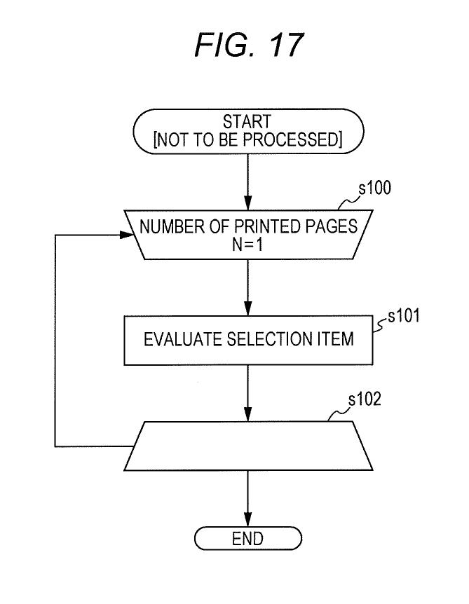

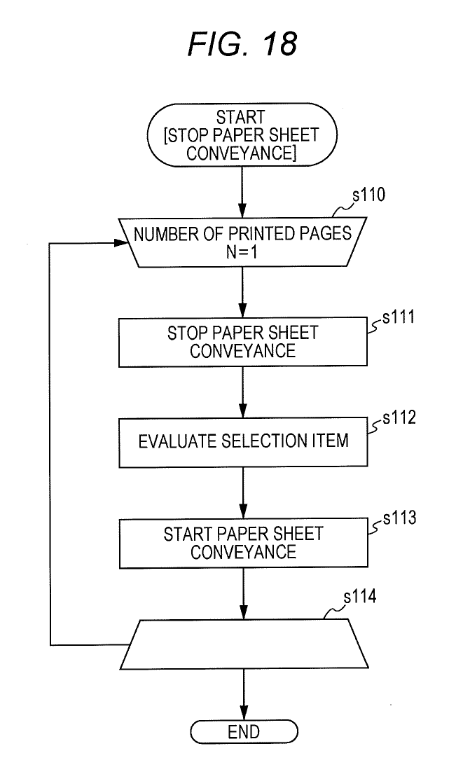

Next, a procedure on an item which is not processed is illustrated in FIG. 17.

One is set as an initial value of the number of printed pages N (step s100), and processing can be repeatedly performed to the final page (step s102).

During the repeated processing, the selection item is evaluated, and the processing is repeatedly performed to the final page.

Next, a procedure of evaluating the selection item by stopping the paper sheet conveyance will be described.

One is set as an initial value of the number of printed pages N (step s110), and processing can be repeatedly performed to the final page (step s114).

During the repeated processing, the paper sheet conveyance is stopped (step s111), and after that, the selection item is evaluated (step s112). Thereafter, the paper sheet conveyance is started (step s113), and one is added to N, and the processing is repeated to the final page. In a case where the productivity cannot be achieved in some pages, this example may be processing of stopping the paper sheet conveyance of the pages in which the productivity cannot be achieved.

In the above embodiment, change in a conveyance time interval of the paper sheet has not been described. However, the conveyance time interval may be changed since a conveying speed is different for each job. For example, productivity can be set to be slow in a case of walnuts, cardboards, and the like. The conveyance time interval can be set by a part of the function of the program executed by the controller, and the part of the function corresponds to a conveyance time setter of the present invention.

Furthermore, in the above embodiment, as the inspection item is selected, the conveying speed and the conveyance time interval may be changed. For example, in a case where it is desired to employ as many kinds of inspection items as possible, the inspection items can be selected while preventing deterioration in the productivity.

The present invention has been described above based on the embodiment. However, the present embodiment can be appropriately modified without departing from the scope of the present invention.

According to an embodiment of the present invention, an effect is obtained in which an inspection item to be inspected in image determination can be appropriately selected. In addition, in a case where a user manually sets an inspection item, setting can be performed as constantly confirming whether all the set inspection items can be inspected within a time corresponding to predetermined productivity, and both the productivity and convenience of setting the inspection items can be achieved.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection device for performing image determination by a plurality of inspection items, the device comprising:
an image reader that obtains an image reading result obtained by reading an image on a transfer medium;
an operator that receives an operation input of a user;
a hardware processor that receives an input to select an inspection item by the operator from among inspection items which can be set, and performs image determination by decided inspection item on the image reading result read by the image reader; and
a notifier that notifies whether the inspection item received by the hardware processor can be inspected within a time corresponding to predetermined productivity.

2. The image inspection device according to claim 1, wherein a priority of the inspection item is preset and stored.

3. The image inspection device according to claim 1, further comprising:
a priority selector that selects an inspection item to be inspected in the image determination according to a predetermined priority relative to the plurality of inspection items, wherein
the hardware processor accepts a change in the inspection item after the priority selector has selected the inspection item.

4. The image inspection device according to claim 3, wherein the priority selector sets a priority of an inspection item which is used in the image determination with high frequency to be high.

5. The image inspection device according to claim 3, wherein the priority selector sets a priority of an inspection item with which it is determined that an image is defective at high frequency to be high.

6. The image inspection device according to claim 3, wherein the priority selector stores the image determination result and a job in association with each other, obtains correlation between the job and the image determination result, and sets a priority of an inspection item having high correlation to be high at the time of the determination.

7. The image inspection device according to claim 1, further comprising: a priority selector that sets a priority of the inspection item based on the inspection item input by the operator.

8. The image inspection device according to claim 1, wherein, in a case where an inspection item used for the image determination is set by the operator, when the inspection item used for the image determination is not appropriate, the notifier notifies that the inspection item is not appropriate.

9. The image inspection device according to claim 4, wherein, in a case where an inspection item used for the image determination is set by the operator, when the inspection item used for the image determination is not appropriate, the hardware processor enables the operator to input an inspection item again.

10. The image inspection device according to claim 4, wherein when the inspection item can be set by the operator, the notifier notifies a processing time for each inspection item.

11. The image inspection device according to claim 1, wherein the hardware processor determines whether an inspection item can be inspected within a time corresponding to predetermined productivity each time when an inspection item is added by the hardware processor and adds the inspection item if the inspection can be performed.

12. The image inspection device according to claim 1, wherein the notifier issues a notification when an inspection item is selected so that a determination time obtained by adding processing times of the selected inspection items is within a predetermined conveyance time interval of the transfer medium.

13. The image inspection device according to claim 11, wherein the hardware processor further performs determination by adding other inspection items in a case where the other inspection items can be determined within the conveyance time interval as a result of the determination with the selected inspection items.

14. The image inspection device according to claim 11, wherein the notifier sets actual data at the time of inspection or assumed data as a processing time of the inspection item in a part of or all of the plurality of inspection items.

15. The image inspection device according to claim 14, wherein the actual data is obtained in a part of or all of the plurality of inspection items by executing a proof job.

16. The image inspection device according to claim 14, wherein in a case where there is an inspection item which does not use the actual data, the notifier calculates a determination time by using a preset processing time.

17. The image inspection device according to claim 1, wherein, when notifying the inspection item to be used for the image determination, the notifier notifies an inspection item used for the image determination and an inspection item which is not used for the image determination in a state where the inspection items can be distinguished from each other.

18. The image inspection device according to claim 17, wherein the notifier notifies a processing time for each inspection item when the inspection item is notified.

19. The image inspection device according to claim 1, wherein the hardware processor enables the selection to be made for each page of the transfer medium or for each job for forming an image on the transfer medium.

20. The image inspection device according to claim 1, wherein the hardware processor sets a conveyance time interval of the transfer medium according to a kind of a job.

21. An image forming system comprising: the image inspection device according to claim 1; and an image forming device that forms an image on a transfer medium.

22. A non-transitory recording medium storing a computer readable program, executed by an image inspection device for performing image determination by a plurality of inspection items, causing the image inspection device to perform:
obtaining an image reading result obtained by reading an image on a transfer medium;
receiving an input to select an inspection item by an operator from among inspection items which can be set;
notifying whether the received inspection item can be inspected within a time corresponding to predetermined productivity; and
performing image determination by using decided inspection items on the image reading result.
